(19) United States
(12) Patent Application Publication
(10) Pub. No.: US 2016/0207382 A1
(43) Pub. Date: Jul. 21, 2016

(54) Torque Indicating Tarp Deployment Actuator

(71) Applicants: Everest Damsi, (US); Albert V. Damsi, (US); Tarpstop, LLC, Perrysburtg, OH (US)

(72) Inventors: Everest Damsi, Perrysburg, OH (US); Albert V. Damsi, Perrysburg, OH (US)

(21) Appl. No.: 14/597,341

(22) Filed: Jan. 15, 2015

(51) Int. Cl. B60J 7/06; F16H 25/20

(52) U.S. Cl. CPC B60J 7/067; F16H 25/2021

(57) ABSTRACT

A deployable trailer coving system includes spaced apart guide tracks mounted on opposite sides of a flat bed trailer. Each of the guide tracks support trolley assemblies support bows for movement along the length of the trailer. The bows support a trailer covering or tarp cover to define a cargo area. A tensioning mechanism is connected to at least one of the bows and applies a load to stretch the covering to a predetermined tension. The tensioning mechanism includes a torque-indicating tensioning actuator that produces one of an audible and a tactile sensation is produced when the predetermined level of tension in the covering is reached.

### BACKGROUND OF THE INVENTION

This invention relates in general to deployable trailer covering systems, such as can be used to create an enclosed cargo area on a flatbed trailer or the like. In particular, this invention relates to a deployable trailer covering system that may utilize a fabric tarp covering having an improved deployment mechanism that indicates when the desired deployed tension is achieved.

Flatbed trailers are often used to haul loads that are bulky or heavy. These loads often have loading and unloading characteristics that rely on access to the open sides of the trailer for loading and unloading. Flatbed trailers provide open access for handling freight but lack a structure for conveniently covering the loads from the elements or for privacy. Tarps are often used to protect freight carried on a flatbed. Sometimes the tarps are applied directly over the loads to guard against the elements. Other flatbed covers rely on bows and other support structures to create a space over the trailer and support one or more tarp sheets. While these structures cover the flatbed trailer and create an enclosed freight hauling space, the structures are difficult or cumbersome to remove in order to gain side access of the trailer for freight handling. In addition, improper deployment of tarp structure may result in overloading or under-loading the covering, such as a fabric tarp covering, which may result in damage to the system. Overloading the tarp structure may result in bending the support bow system or tearing the fabric covering. Under-loading the tarp structure causes the fabric to wrinkle or otherwise fail to be taut. This condition allows the fabric to flap in response to air pressure and wind. As the fabric moves relative to the support structure, excessive wear occurs causing damage to the covering and potentially the cargo inside. Thus, it would be desirable to provide an mechanism to indicate when the tarp system has been properly deployed.

### SUMMARY OF THE INVENTION

This invention relates to a deployable trailer covering system having a torque responsive deployment mechanism. These deployable trailer covering systems may include a rigid covering or a fabric covering. In a particular embodiment, this invention relates to a fabric based trailer tarp covering system that is deployed by a torque generating device that indicates when the proper load has been applied to deploy the system.

The torque generating device may be in the form of an offset crank handle having a torque indicating capability that produces one of an audible and tactile sensation that alerts a user when the desired or proper tension has been imparted to the fabric trailer cover. This tension level is associated with the torque to actuate the tarp covering system and may be set as a predetermined torque level or may be an adjustable torque level that is set in response to the type of fabric covering used.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a flatbed trailer with a deployable trailer covering system in accordance with this invention.

FIG. 2A is an enlarged perspective view of a portion of the flatbed trailer and deployable trailer covering system of FIG. 1.

FIG. 2B is an enlarged view of a tarp tensioning mechanism, including an embodiment of a torque indicating tensioning actuator, that is part of the deployable trailer covering system of FIG. 1.

FIG. 3 is an exploded view of the embodiment of the torque-indicating tensioning actuator of FIG. 2B.

FIG. 4A is an enlarged, perspective view of a torque-responsive, indicating mechanism in a neutral position.

FIG. 4B is an enlarged, perspective view of the torque-responsive, indicating mechanism in a position indicating that the desired torque level has been achieved.

FIG. 5A is an elevational view of another embodiment of a torque indicating tarp tensioning actuator in accordance with the invention.

FIG. 5B is a cross sectional side view of the torque indicating tarp deployment actuator taken along line 5B-5B.

FIG. 5C is a cross sectional end view of the torque indicating tensioning actuator taken along line 5C-5C.

FIG. 6 is yet another embodiment of a torque indicating tensioning actuator in accordance with the invention.

### DETAILED DESCRIPTION OF THE PREFERRED EMBODIMENT

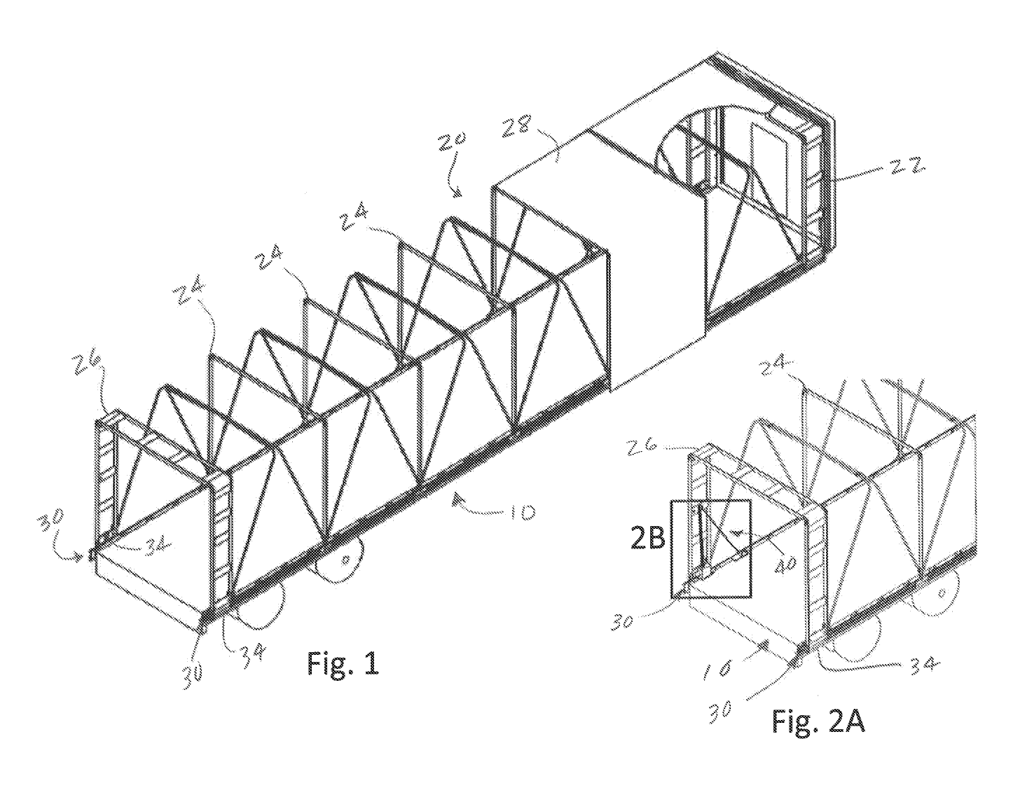

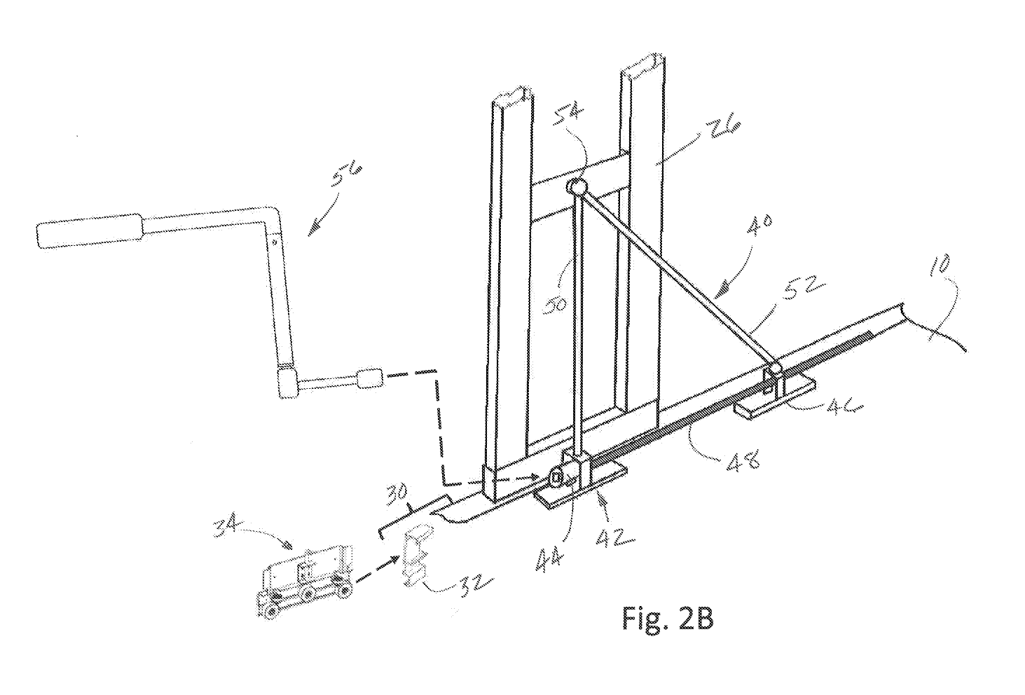

Referring now to the drawings, there is illustrated in FIGS. 1, 2A and 2B a flatbed trailer, shown generally at 10, that is covered by a deployable trailer covering system, shown generally at 20. The deployable trailer covering system 20 includes a plurality of bows including a front bow 22, a plurality of intermediate bows 24, and a rear bow 26. A tarp covering 28 can be attached between the respective bows 22, 24, and 26 or, alternatively, a single tarp can be stretched along a length of the flatbed trailer 10. The ends of the bows 22, 24, and 26 are supported on a rolling track system, shown generally at 30, that is provided on opposite sides of the flatbed trailer 10. Thus, the deployable trailer covering system 20 can be extended along a deck of the flatbed trailer 10 to create an enclosed cargo area or can be retracted when not in use. Although the deployable trailer covering system 20 is illustrated for use with a flatbed trailer 10, it should be appreciated that the tarp system 20 can be used in any desired environment and for any desired purpose. For example, in addition to the trucking industry, the deployable trailer covering system 20 may also be used in the rail and shipping industries or any other industry.

The rolling track system 30 includes a pair of guide tracks 32 that respectively extend along opposite sides of the flatbed trailer 10. The guide tracks 32 form channels that accept trolley assemblies 34. The guide tracks and trolleys are similar to those disclosed in U.S. Patent Publication No. 2013-0249237 A1, the disclosure of which is incorporated herein by reference in its entirety. The trolley assemblies 34 are configured to roll or otherwise translate relative to the guide tracks 32. The trolley assemblies 34, located on opposite sides of the trailer 10, are interconnected by a bow element 36 to form the various bows 22, 24, and 26. At least one of the trolley assemblies 34 is attached to a tensioning mechanism, shown generally at 40. In the illustrated embodiment, the tensioning mechanism 40 includes a tensioning head 42 having a torque transmitting drive unit 44 and a reaction end 46. An actuator 48, such as an ACME screw, pulley and cable system, hydraulic pump, or any other suitable mechanism configured to move the attached trolley assembly 34 relative to the guide tracks 32, is connected between the tensioning head 42 and the reaction end 46. Movement of the trolley assemblies 34 by the tensioning mechanism 40 causes the plurality of intermediate bows 24 to move along the guide tracks 32 and tension the tarp covering 28 when the front bow 22 is fixed relative to the guide tracks 32.

In the illustrated embodiment, the tensioning mechanism is illustrated as an A-frame tensioning mechanism, having first and second support legs 50 and 52 that connect the tensioning head 42 and the reaction end 46, respectively, to the rear bow 26 by a junction point 54. As the torque transmitting drive unit 44 is rotated, the ACME screw thread actuator 48 drives the tensioning head 42 and the reaction end 46 relative to the trailer 10. The junction point 54 is detachably connected to the rear bow 26. As rotation of the ACME screw actuator 48 causes the support legs 50, 52 and junction point 54 to move the rear bow 26 along the guide track 32, the tarp covering 28 becomes taut. During the tarp tensioning procedure, the tensioning head 44 is rotated by a torque-indicating tensioning actuator, shown generally at 56.

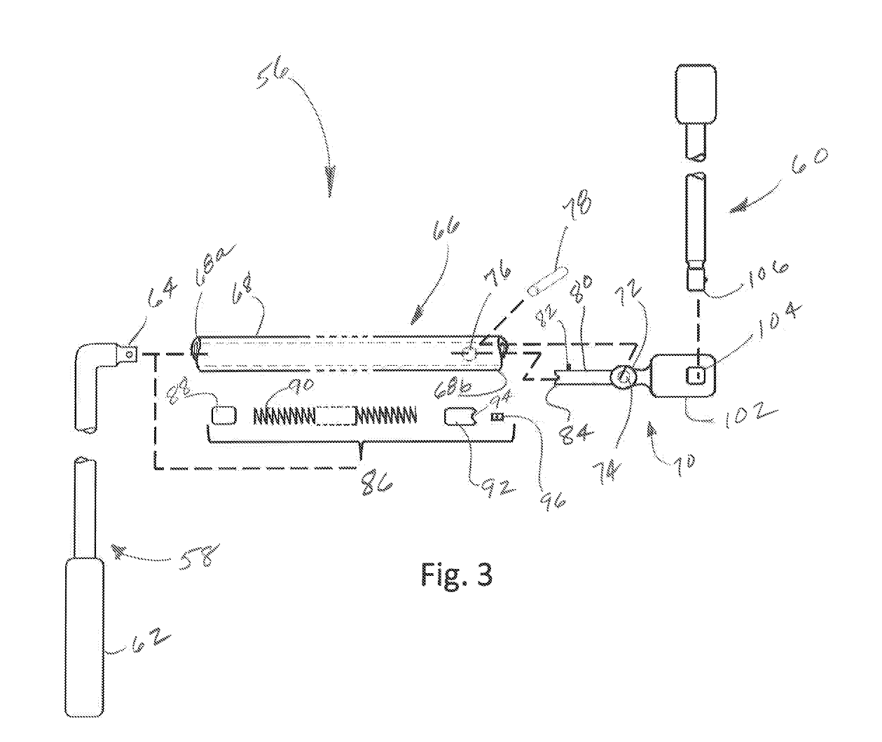

Referring now to FIG. 3, the torque-indicating tensioning actuator 56 is illustrated as an offset crank configuration, though any suitable torque transmitting configuration may be used. The torque-indicating tensioning actuator 56 includes a handhold end, shown generally at 58, and a driving end, shown generally at 60. The driving end 60 is configured to mate with the tensioning head 44 such that the tensioning mechanism 40 can be actuated. The handhold end 58 includes a grip 62 and a drive connection 64. The drive connection 64 may be permanently fixed to or detachably fixed to a torque-responsive, indicating assembly, shown generally at 66. The torque-responsive, indicating assembly 66 includes an outer member 68, illustrated as a hollow, tubular section, that receives torque inputs and rotary motion from the handhold end 58 and transmits them to the driving end 60 and then to the tensioning head 44. The outer member 68 and the drive connection 64 are attached at a first end 68a such that torque is transmitted from the handhold end 58 to the driving end 60 through the outer member 68. The outer member 68 accepts the drive connection 64 as either a permanently fixed attachment (i.e., a connection that is not intended to be separated once assembled) or a detachably fixed attachment. In general, the attachment of the drive connection 64 to the outer member 68 is torque transmitting and stable in bending so as not to permit substantial bending movement between the handhold end 58 and the torque-responsive, indicating assembly 66 during use.

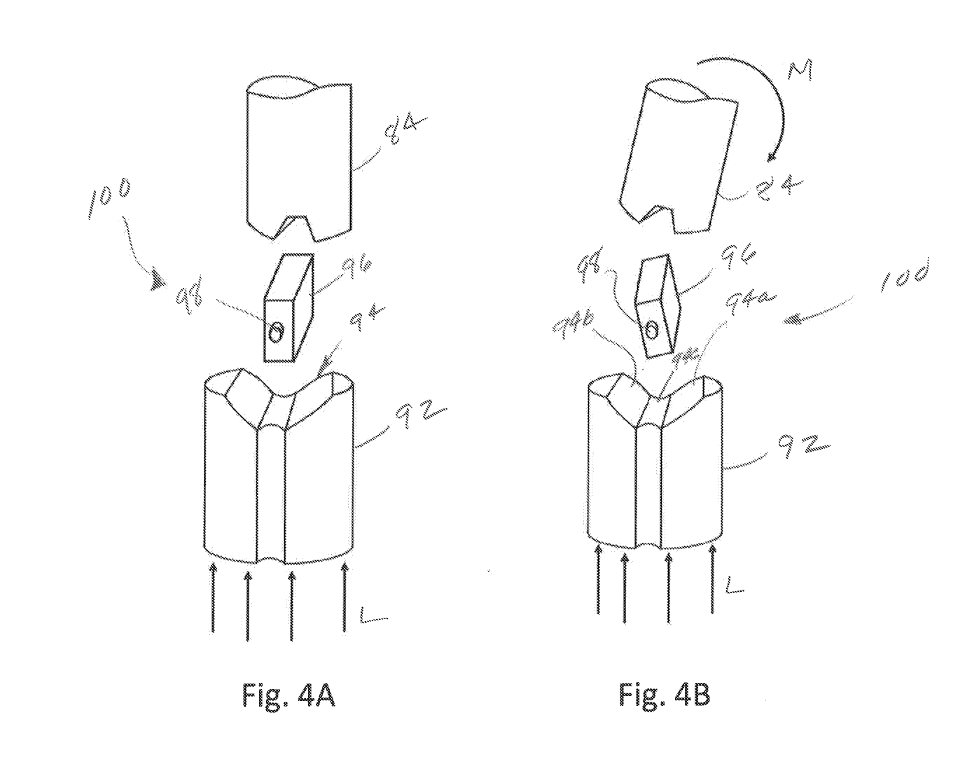

The outer member 68 is pivotally connected at a second end 68b to a torque reaction beam, shown generally at 70. The torque reaction beam 70 is pivotally connected at a fulcrum point 72, illustrated as a spherically shaped pivot point that is received within the outer member 68. The fulcrum point 72 includes a fulcrum mounting aperture 74 that aligns with an outer member aperture 76. The aligned apertures 74 and 76 accept a connection element 78, illustrated as a dowel. The connection element may be any suitable structure such as a roll pin, bolt, rivet, and the like. The torque reaction beam 70 includes a reaction arm 80. The reaction arm 80 includes a biasing stop 82 that prevents a rocking or toggling motion of the reaction arm 80 within the outer member 68 when torque is applied in one direction, but permits motion when torque is applied in the other direction. The reaction arm 80 further includes a first reaction notch 84 that defines a first end of a torque-responsive, indicating mechanism, shown generally at 100 in FIGS. 4A and 4B.

A torque sensitive biasing assembly 86 is positioned within the outer member 68 between the first end 68a and the reaction arm 80 at the second end 68b. The torque sensitive biasing assembly includes a stop 88 that may be fixed within the outer member 68. In one embodiment, the stop 88 is a threaded member that is adjustable to set a spring tension set point of a biasing spring 90. Alternatively, the stop 88 may be a press fit attachment or a pinned attachment to the outer member 68. The biasing spring 90 applies an axial load L against a reaction plug 92, that has a second reaction notch 94. The first and second reaction notches 84 and 94 are generally “V”-shaped and include a flat region 94c between V-shaped walls 94a and 94b. In one embodiment, the second reaction notch 94 includes a wider V-shaped notch, though the wider notch may be applied to the first reaction notch 84. A pivot pin 96 mates with the first and second reaction notches 84 and 94. The pivot pin 96 is generally rectangular in shape and includes ends 98 that are configured to rotate within the outer member 68. In the illustrated embodiment, the ends 98 are illustrated as pins that extend from the pivot pin 96 to the inner surface of the outer member 68. Alternatively, the ends may be spherical in shape.

The torque reaction beam 70 further includes a receiver end 102 that couples the driving end 60 to the outer member 68. The receiver end 102 may include an aperture 104 that mates with a similarly shaped mounting end 106 of the driving end 60. In the illustrated embodiment, the mating end 106 and aperture 104 are configured similarly to a conventional ratchet wrench and socket connection, though any suitable shape may be used. Alternatively, the receiver end 102 may be integrally formed with the driving end 60, if so desired.

Referring now to FIGS. 4A and 4B, when a torque is applied to the torque-responsive, indicating assembly 66 as the handhold 58 is cranked, a bending moment M reacts at the fulcrum point 72 such that the reaction arm 80 toggles within the outer member 68. Movement of the reaction arm 80 is resisted by the axial load L applied to the reaction plug 92 that presses the pivot pin 96 against the first and second reaction notches 84 and 94. When the magnitude of the bending moment M is sufficient to overcome the axial load against the pivot pin 96, the pin 96 and the reaction arm 84 snap laterally within the outer member 68, as shown in FIG. 4B. This lateral motion, or toggling motion, causes at least one of an auditory and tactile sensation that indicates a preset torque level, which is a function of the axial force L. has been achieved. The axial load L is set by the amount of compression exerted on the biasing spring 90. The torque level is chosen such that the tarp covering 28 becomes taut to eliminate flapping or other wear-creating movements yet not so tight that the material will tear or excessive wear and load is imparted to the trolley assemblies 34 and the guide tracks 32. The compression of the biasing spring 90 may be adjustable within a range of values or fixed to a singular value.

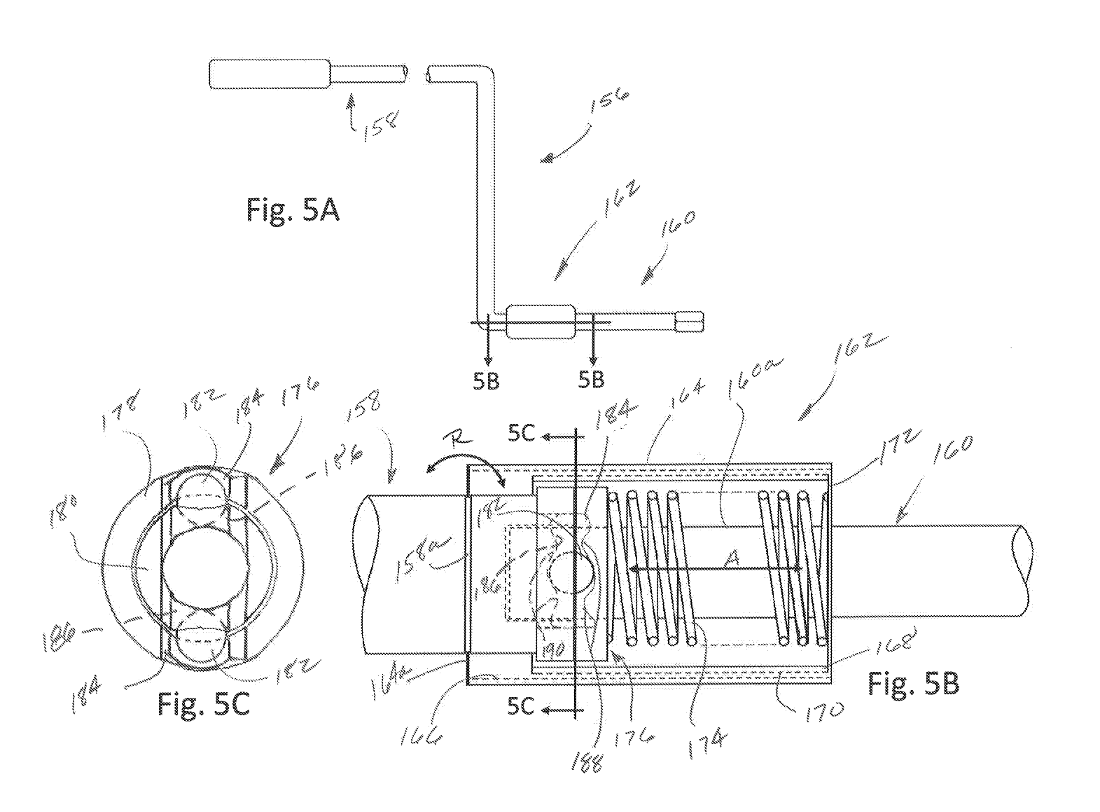

Referring now to FIGS. 5A, 5B, and 5C, there is illustrated another embodiment of a torque-indicating tensioning actuator, shown generally at 156. The torque-indicating tensioning actuator 156 includes a handhold end 158 and a driving end 160. An adjustable torque-responsive, indicating assembly is shown generally at 162. As shown in FIGS. 5B and 5C, the adjustable torque-responsive, indicating assembly 162 includes a torque level adjusting sleeve 164 that is fixed axially relative to the handhold 158 but free to rotate relative thereto. The torque level adjusting sleeve 164 may be axially retained by a groove 158a or flange arrangement, as part of the handhold 158, that traps a retaining flange 164a defining a retaining end that closes around the handhold 158. The torque level adjusting sleeve 164 includes a threaded inner diameter 166. A spring bias sleeve 168 is disposed within the torque level adjusting sleeve 164 and includes a threaded outer diameter 170 that engages the threads within the adjusting sleeve 164, such that rotation R of the adjusting sleeve 164 causes axial movement A of the biasing sleeve. The biasing sleeve 168 further includes a spring seat 172 configured generally as an annular flange that permits a shaft portion 164a of the driving end 164 to extend therethrough.

A biasing spring 174 is disposed within the biasing sleeve 168 and around the shaft portion 160a of the driving end 160. One end of the biasing spring 174 abuts the spring seat 172. The opposite end of the biasing spring 174 abuts a torque-responsive, indicating assembly, shown generally at 176. The torque-responsive indicating assembly 176 includes first and second abutting load disks 178 and 180 and at least one indicating ball 182 disposed therebetween. The illustrated embodiment shows two indicating balls 182 spaced 180 degrees apart, though any suitable number may be provided. Typically the indicating balls 182 may be evenly spaced between the load disks 178 and 180, though such is not required. As shown in FIGS. 5B and 5C, load disk 178 includes torque pockets 184 that face corresponding torque pockets 186 formed in the load disk 180. The torque pockets 184 and 186 are illustrated having a generally sinusoidal shape that traps the indicating ball 182. The torque pockets 184 and 186 further define peaks 188 and 190 adjacent to the ball 182.

As the torque level adjusting sleeve 164 is rotated relative to the spring biasing sleeve 168, the biasing spring is compressed or relaxed against the mating load disks 178 and 180. The magnitude of axial force against the load disks 178 and 180 determines the torque level required to compress the biasing spring 174 and cause the ball 182 to snap over the peaks 188 and 190. The snapping action of the ball 182 provides at least one of an auditory and a tactile sensation to alter the user that the proper torque level and tarp tension has been achieved.

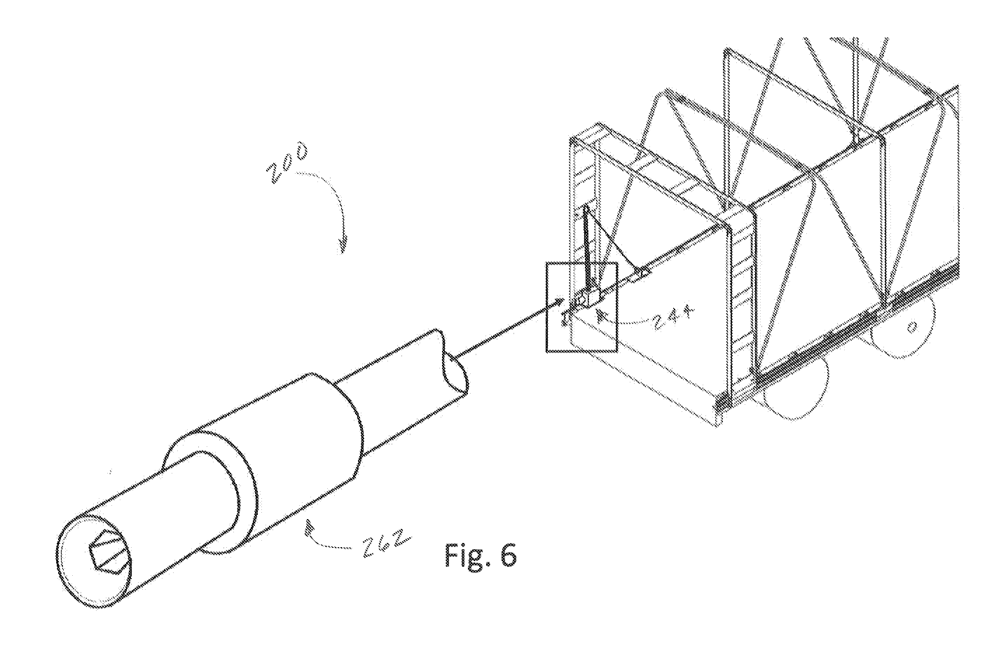

Referring now to FIG. 6, there is illustrated an embodiment of a torque-indicating tensioning actuator, shown generally at 200. The torque indicating tensioning actuator 200 includes an adjustable torque-responsive, indicating assembly, shown generally at 262 which is similar in construction and operation to the adjustable torque-responsive, indicating assembly 162, described above. The torque indicating tensioning actuator 200 is part of a tensioning head 244, that is similar to tensioning head 44, described above. In this embodiment, the ability to produce a torque sensitive reaction that provides an auditory or tactile sensation that the torque level and tarp tension has been achieved is provided in the tensioning mechanism attached to the flatbed trailer. Thus, any suitable handle may be used to apply the necessary torque and rotary motion to tension the tarp assembly.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A deployable trailer coving system comprising:
spaced apart guide tracks that each support a plurality of trolley assemblies for relative movement therewith;
a plurality of bows connected between the plurality of trolley assemblies in the spaced-apart guide tracks, the plurality of bows supporting a covering to define a cargo area; and
a tensioning mechanism connected to at least one of the plurality of bows and configured to apply a tension level to the covering, the tensioning mechanism including a tensioning head and a torque-indicating tensioning actuator, the torque-indicating tensioning actuator configured to mate with the tensioning head such that at least one of an audible and a tactile sensation is produced when the tension level is reached.

2. The deployable trailer covering system of claim 1 wherein the tensioning mechanism is an A-frame tensioning mechanism connected to the tensioning head by a screw thread actuator and wherein the torque-indicating tensioning actuator includes a torque-responsive, indicating assembly that produces the at least one audible and tactile sensation.

3. The deployable trailer covering system of claim 1 wherein the spaced apart guide tracks are supported on opposite sides of a flatbed trailer, the tensioning mechanism is connected between the flatbed trailer and the at least one of the plurality of bows, and wherein the torque-indicating tensioning actuator includes a torque-responsive, indicating assembly having a torque sensitive biasing assembly.

4. The deployable trailer covering system of claim 3 wherein the torque indicating tensioning actuator includes a handhold end and a driving end, the torque sensitive biasing assembly includes a biasing spring disposed between a stop proximate to the handhold end and a reaction plug, the distance between the stop and the reaction plug defining a spring tension set point that is associated with the tensioning level.

5. The deployable trailer covering system of claim 4 wherein the torque sensitive biasing assembly includes a pivot pin positioned between a reaction arm of the driving end and the reaction plug, the pivot pin generating the at least one of the audible and tactile sensation indicating that the tensioning level has been reached.

6. The deployable trailer covering system of claim 4 wherein the stop is adjustable to vary the spring tension set point.

7. The deployable trailer covering system of claim 4 wherein the spring tension set point is a fixed value.

8. The deployable trailer covering system of claim 4 wherein the torque-indicating tensioning actuator includes an outer member, the driving end including a receiver end configured to connect to the tensioning head, the torque sensitive biasing assembly is disposed within the outer member and includes a pivot pin positioned between a reaction arm pivotally connected to the driving end and the reaction plug, the pivot pin generating the at least one of the audible and tactile sensation indicating that the tensioning level has been reached.

9. A tensioning mechanism for a trailer tarp system, the tensioning mechanism comprising:
a tensioning frame;
a screw thread actuator connected to the tensioning frame;
a tensioning head connected to the screw thread actuator such that rotation of the screw thread causes a tensioning load having an upper load limit to be applied to the tensioning frame, the tensioning head including a torque-responsive, indicating assembly that produces the at least one audible and tactile sensation when the tensioning upper load limit is reached.

10. The tensioning mechanism of claim 9 wherein the torque-responsive indicating assembly includes a torque sensitive biasing assembly that is responsive to the tensioning upper load limit to produce the at least one audible and tactile sensation indicating the upper load limit has been reached.

11. The tensioning mechanism of claim 10 wherein the torque sensitive biasing assembly is configured as a spring and a reaction plug, the reaction plug cooperating with a pivot pin to produce the at least one audible and tactile sensation.

12. The tensioning mechanism of claim 10 wherein the torque sensitive biasing assembly is configured as a spring, first and second abutting load disks, and at least one indicating ball.

13. The tensioning mechanism of claim 10 wherein the torque sensitive biasing assembly is adjustable to vary the value of the tensioning upper load limit.

14. The tensioning mechanism of claim 10 wherein the torque sensitive biasing assembly is configured to have a preset upper load limit value.
